(19) United States
(12) Patent Application Publication
(10) Pub. No.: US 2010/0250746 A1
(43) Pub. Date: Sep. 30, 2010

(54) INFORMATION TECHNOLOGY SOURCE MIGRATION

(75) Inventor: Atsushi MURASE, Sunnyvale, CA (US)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/413,902

(22) Filed: Mar. 30, 2009

(51) Int. Cl. G06F 15/173; G06F 12/00; G06F 12/16

(52) U.S. Cl. 709/226; 709/223; 711/162; 711/E12.001; 711/E12.103

(57) ABSTRACT

A method of managing IT sources among a first computer system and at least one computer service system comprises obtaining a resource utilization trend of the first computer system based on a history of utilization of an IT resource in the first computer system; obtaining a data sending throughput rate from the first computer system to each of the at least one computer service system; and, based on the resource utilization trend and the data sending throughput rate, selecting a target computer service system to migrate a workload from the first computer system, determining a start time to start a precede data copy associated with the workload to be migrated, prior to switching over processing of the workload at a switching time, and starting the precede data copy from the first computer system to the target computer service system at the start time.

### BACKGROUND OF THE INVENTION

The present invention relates generally to managing IT sources and, more particularly, to an IT source migration technique to shorten or eliminate the application disruptive time due to the data copy time from the on premise site to the off premise cloud service provider's site associated with the IT source migration.

An IT system is now a mandatory component of companies to carry out their everyday business. Because the IT system becomes larger and more complex, the cost to design, build, and manage the IT system dramatically increases year by year. Furthermore, for a company which has application systems (e.g., a web ticketing system) that encounters spiky increases of transaction workload in a short period of time although it does not have much workload in general time wise, it is very costly to build and manage the large IT system based on its maximum workload amount.

To provide the required amount of IT resources elastically or flexibly in order to handle those temporary and drastic increases in workload, “cloud service” providers have emerged. They offer services for companies or end users to utilize the required amount of IT resource via the Internet, which has been built and is managed at cloud service providers' datacenter, to be paid by the time and amount utilization of resources. Actually, “application service providers” were in existence before; however, due to the lack of network bandwidth, for instance, such service business was not widely accepted in those early days. In accordance with the innovation of improved network speed, and also the emergence of virtual server and storage technologies enabling more dynamic provisioning of IT resources, business application outsourcing via the Internet is being offered in more realistic latency and price. Therefore, the cloud service provider market has become a reality and it continues to grow.

Examples of cloud service providers include those outsourcing technology of IT system via the Internet with usage based payment, such as Amazon Web Services (http://aws.amazon.com), Google App Engine (http://code.google.com/intl/en/appengine), and Salesforce.com/Force.com (https://www.salesforce.com/platform/). An example of monitoring I/O throughput of cloud service is Hyperic CloudStatus (http://www.cloudstatus.com). An example of virtual server management technologies is VMware virtual server management products (http://www.vmware.com/products/vi/vc/, http://www.vmware.com/products/vi/vc/vmotion.html).

Generally, cloud service providers have a huge size of IT resources, and have very elastic capabilities to accept spiky increases of workload of independent users. Thus, companies that provide such a characteristic of applications have begun to use not only their on premise systems but also off premise IT resource services for those applications. Client companies that use these services might use only off premise resource, but another use case is conceivable. A company may use on premise resource for normal time and, once the workload increases dramatically, it may migrate workloads to the off premise site to process temporarily a large amount of workload. After the peak in workload has passed, the company retrieves the reduced workloads to the on premise site again and pays the fee for the utilization of the off premise resource at that time to the cloud service provider. This type of use case can be considered an efficient use of on/off premise IT resources.

New issues regarding with the use case of migrating workloads from the on premise site to the off premise site have emerged, however. For example, in the situation involving a drastic increase of workloads, a huge size of application data copy from the on premise site to the off premise site is needed. Moreover, against such a situation that is disruptive of new virtual server/storage element, provisioning process time is needed continuously in accordance with the workload growth in the computer service system.

### BRIEF SUMMARY OF THE INVENTION

Exemplary embodiments of the invention provide a solution to shorten the time to switch over the workload from the on premise site to the off premise site with an efficient data copy method, and a rapid and automated resource provisioning method to provide the proper amount of resource according to the growth of the workload in the computer service system.

An aspect of the present invention is directed to a method of managing IT (Information Technology) sources among a first computer system and at least one computer service system which are connected with a network. The method comprises obtaining a resource utilization trend of the first computer system based on a history of utilization of an IT resource in the first computer system; obtaining a data sending throughput rate from the first computer system to each of the at least one computer service system; selecting, based on the resource utilization trend and the data sending throughput rate, a target computer service system among the at least one computer service system to migrate a workload from the first computer system to the target computer service system; determining, based on the resource utilization trend and the data sending throughput rate, a start time to start a precede data copy associated with the workload to be migrated from the first computer system to the target computer service system, prior to switching over processing of the workload to be migrated from the on premise system to the target computer service system at a switching time; and starting the precede data copy associated with the workload to be migrated from the first computer system to the target computer service system at the start time.

In some embodiments, obtaining the data sending throughput rate comprises sending a small amount of data from the first computer system to each of the at least one computer service system periodically to obtain a real-time data sending throughput rate for each of the at least one computer service system. The determining includes determining the start time such that a difference between the start time and the switching time is at least equal to an estimated copy time of a total amount of data associated with the workload to be migrated from the first computer system to the target computer service system. The starting of the precede data copy is triggered when remaining time to consume rest of the IT resource in the first computer system calculated based on the resource utilization trend becomes lower than the estimated copy time plus a margin.

In specific embodiments, the method further comprises migrating the workload from the first computer system to the target computer service system either immediately after completion of the precede data copy or by an independent trigger. If the independent trigger is activated and the precede data copy has not been completed, migration of the workload waits until the precede data copy is completed. The method may further comprise transferring the resource utilization trend of the first computer system to the target computer service system during migration of the workload to the target computer service system. The IT resource includes at least one of virtual server instances and storage capacity. The method further comprises starting automated virtual server provisioning in the target computer service system based on the resource utilization trend transferred from the first computer system.

In some embodiments, the at least one computer service system includes at least one cloud service system; and the first computer system is one of an on premise computer system or another cloud service system. The method further comprises monitoring both a server resource consumption trend and a storage resource consumption trend of the first computer system; determining which of the server resource and the storage resource will be first to be consumed down to a corresponding threshold level, the threshold level being equal to or greater than zero; calculating a consumed storage amount of the storage resource when the threshold level is first reached; and using the calculated consumed storage amount for determining the start time. For example, if the storage resource is first to be consumed down to the threshold level before the server resource, the calculated consumed storage amount will be the entire size of the storage pool if the threshold level is zero or will be the entire size of the storage pool minus the threshold level if it is non-zero. If the server resource is first to be consumed down to the threshold level before the storage resource, the consumed storage amount will be calculated based on the storage resource utilization trend at the time when the server resource reaches the threshold level. In either case, the calculated consumed storage amount will be precede copied to the target computer service system and hence is used for determining the start time.

In specific embodiments, the method further comprises selecting the target computer service system which has a shortest copy time for the precede data copy. The target computer service system having the shortest copy time is selected by referring to a data transfer performance summary table containing, for each computer service system, an ID, an I/O throughput rate, and an estimated copy time. The method further comprises, after completion of migrating the workload from the first computer system to the target computer service system, directing an access target for the first computer system to the target computer service system instead of to the first computer system.

In accordance with another aspect of the invention, a management system for managing IT (Information Technology) sources comprises a first computer system; at least one computer service system; and a service director computer connected to the first computer system and the at least one computer service system via a network. The service director computer obtains a resource utilization trend of the first computer system based on a history of utilization of an IT resource in the first computer system; obtains a data sending throughput rate from the first computer system to each of the at least one computer service system; selects, based on the resource utilization trend and the data sending throughput rate, a target computer service system among the at least one computer service system to migrate a workload from the first computer system to the target computer service system; determines, based on the resource utilization trend and the data sending throughput rate, a start time to start a precede data copy associated with the workload to be migrated from the first computer system to the target computer service system, prior to switching over processing of the workload to be migrated from the on premise system to the target computer service system at a switching time; and starts the precede data copy associated with the workload to be migrated from the first computer system to the target computer service system at the start time.

Another aspect of the invention is directed to a computer-readable storage medium storing a plurality of instructions for controlling a data processor to manage IT (Information Technology) sources among a first computer system and at least one computer service system which are connected with a network. The plurality of instructions comprise instructions that cause the data processor to obtain a resource utilization trend of the first computer system based on a history of utilization of an IT resource in the first computer system; instructions that cause the data processor to obtain a data sending throughput rate from the first computer system to each of the at least one computer service system; instructions that cause the data processor to select, based on the resource utilization trend and the data sending throughput rate, a target computer service system among the at least one computer service system to migrate a workload from the first computer system to the target computer service system; instructions that cause the data processor to determine, based on the resource utilization trend and the data sending throughput rate, a start time to start a precede data copy associated with the workload to be migrated from the first computer system to the target computer service system, prior to switching over processing of the workload to be migrated from the on premise system to the target computer service system at a switching time; and instructions that cause the data processor to start the precede data copy associated with the workload to be migrated from the first computer system to the target computer service system at the start time.

These and other features and advantages of the present invention will become apparent to those of ordinary skill in the art in view of the following detailed description of the specific embodiments.

### BRIEF DESCRIPTION OF THE DRAWINGS

FIG. 1 illustrates an example of a hardware configuration in which the method and apparatus of the invention may be applied.

FIG. 2 illustrates an example of a logical configuration of the invention applied to the architecture of FIG. 1.

FIG. 3 illustrates an example of a logical configuration showing the behavior for dynamic server/storage resource provisioning and its migration.

FIG. 4 illustrates an exemplary data structure of Server Resource Utilization History Table.

FIG. 5 illustrates an exemplary data structure of Storage Resource Utilization History Table.

FIG. 6 illustrates an exemplary data structure of Server Resource Utilization Trend Table.

FIG. 7 illustrates an exemplary data structure of Storage Resource Utilization Trend Table.

FIG. 8 illustrates an exemplary data structure of Cloud Service Information Table.

FIG. 9 illustrates an exemplary data structure of Cloud Service Data Transfer Performance History Table.

FIG. 10 illustrates an exemplary data structure of Cloud Service Data Transfer Performance Summary Table.

FIG. 11 is a flow diagram illustrating an example process of updating performance information of cloud services.

FIG. 12 is a flow diagram illustrating an example process of migration target cloud service determination and precede data copy.

FIG. 13 is a flow diagram illustrating an example process of entire workload migration from On Premise System to selected Cloud Service System.

FIG. 14 is a flow diagram illustrating an example process of automated virtual server provisioning based on the resource utilization trend information.

FIG. 15 is a flow diagram illustrating an example process of adjusting the required number of virtual servers for execution.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment”, “this embodiment”, or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing”, “computing”, “calculating”, “determining”, “displaying”, or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for an IT source migration technique to shorten or eliminate the application disruptive time due to the data copy time from the on premise site to the off premise cloud service provider's site.

1. Hardware Architecture

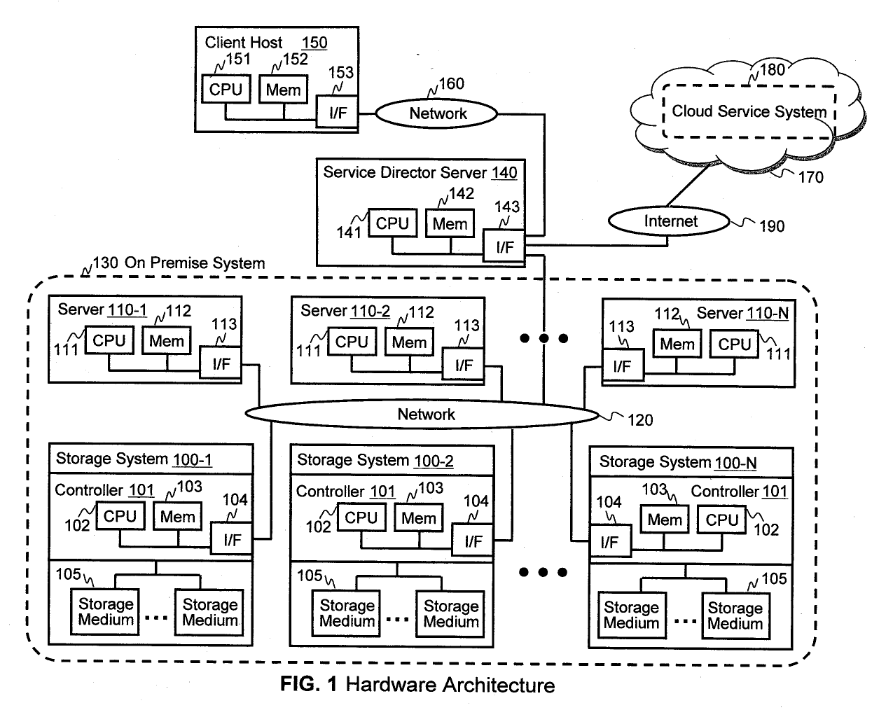

FIG. 1 shows an example of the physical hardware architecture of a system according to an embodiment of the invention.

1) Overall System

The On Premise System 130 and Cloud Service System 180 are both connected to the Service Director Server 140 via the network 120 and Internet 190, respectively. The Service Director Server 140 and Client Host 150 are also connected by the network 160. The On Premise System 130 includes plural storage systems 100 and plural servers 110, and they are connected to each other by the network 120. The Cloud Service System 180 may be composed of similar components and structure as the On Premise System 130; however, as far as it provides computing and storage resource logically, its system structure can be varied. In alternative embodiments, the Service Director Server 140 may be part of the On Premise System 130.

2) Storage System

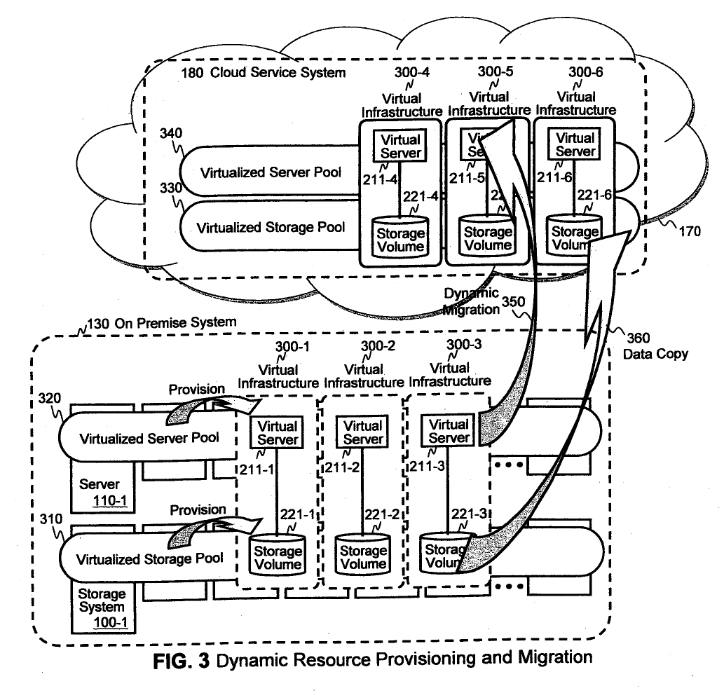

In specific embodiments of this invention, many storage systems 100 are deployed in the On Premise System 130. Physical storage systems 100 are integrated and provide storage capacity as the Virtualized Storage Pool 310 (FIG. 3). Each storage system 100 comprises a controller 101 and plural storage mediums 105. The controller 101 includes CPU 102, memory 103, and network interface 104. The storage mediums 105 are connected to the controller 101 and they could be any of a variety of types of devices such as hard disk, flash memory, optical disk, and the like.

3) Server

In specific embodiments of this invention, many servers 110 are deployed. Physical servers 110 are integrated and provide computing capacity for the Virtualized Server Pool 320 (FIG. 3) as described below. It may be a generic computer that comprises CPU 111, memory 112, and network interface 113.

4) Client Host

The Client Host 150 may be a generic computer that comprises CPU 151, memory 152, and network interface 153. It is a terminal for the end user to access either the On Premise System IT resource or the Cloud Service System IT resource.

5) Service Director Server

Service Director Server 140 may be a generic computer that comprises CPU 141, memory 142, and network interface 143. It directs the IT source access request from the Client Host 150 to either the On Premise System 130 or the Cloud Service System 180. It also manages the lifecycle of virtual server and storage elements. It substantially monitors resource utilization at the on premise site and real time throughput of the cloud services, and determines when to begin the data copy for the workload migration from the On Premise System 130 to the Cloud Service System 180.

As described in the Background of the Invention, new issues regarding with the use case of migrating workloads from on premise to off premise has emerged, however. For example, in the situation involving a drastic increase of workloads, a huge size of application data copy from on premise to off premise is needed. Moreover, against such a situation that is disruptive of new virtual server/storage element, provisioning process time is needed continuously in accordance with the workload growth. The Service Director Server 140 contains features to address these issues.

2. Local Element Structure

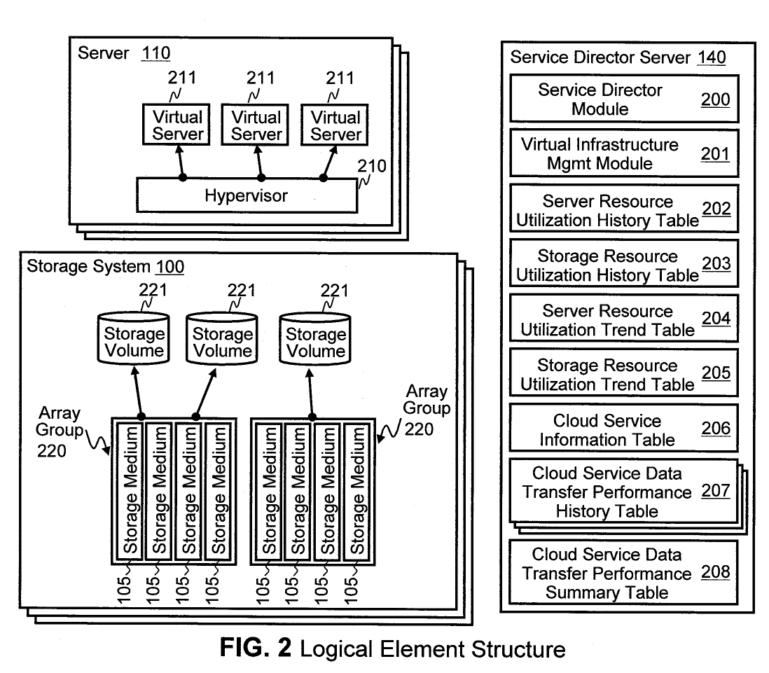

FIG. 2 illustrates an example of a logical configuration of the invention applied to the architecture of FIG. 1.

1) Virtual Servers on Server

Physical servers 110 have hypervisor 210 which can logically produce and perform virtualized server instance of virtual server 211. A single physical server 110 or hypervisor 210 therein can generate and control plural virtual servers 211 at a time. Physical resources such as CPU 111, memory 112, or network interface 113 are shared (or partitioned) with those plural virtual servers 211. Each virtual server 211 can execute applications respectively as if each virtual server 211 were running standalone.

2) Storage Volume Composition of Storage System

The array group 220 is the logical capacity which is composed of plural storage mediums 105 in a so-called RAID group. For example it could be composed as RAID 5 with 3 disks of data and 1 parity disk. The storage volume 221 is another logical capacity which is carved from the array group 220 which is used by the virtual server 211 to read/write data of application it runs.

3) Software on the Service Director Server

The Service Director Module 200 is a key program of embodiments of the invention. It directs the access request from the Client Host 150 to either the On Promise System 130 or the Cloud Service System 180 where target application workloads are running. The Virtual Infrastructure Management Module 201 is another key program of embodiments of the invention. It operates the entire IT operations in this system so as to construct the server/storage resource pool with physical servers 110 and storage systems 100, provisions the required amount of server/storage resource, and forms the logical IT infrastructure.

In specific embodiments of the invention, the Virtual Infrastructure Management Module 201 performs monitoring of the history of how much computing and storage resources have been utilized in the On Premise System 130 and generates the utilization trend information. Based on the trend information, it provisions the proper amount of virtual servers periodically in advance of the actual need of adding them to the cluster of server workloads and queues them to be used. Once those virtual server instances are needed according to the growth of transactions, they will be added to the cluster and turned on from the suspended state.

The Service Director Module 200 periodically checks the I/O performance (data “put” throughput) for migration candidate cloud services by sending a small amount of actual data. It also estimates how much time will be needed to transfer the whole amount of data in the On Premise System 130 to each candidate cloud site based on the measured throughput. It then figures out how much time is left to utilize a certain determined amount (which could be the entire amount) of resource in the On Premise System 130 based on the trend information, which is the time the workloads need to be migrated from the on premise site to the off premise site, and compares it to the estimated time of data copying above to each cloud service site. If they are close enough, the Service Director Module 200 determines the migration target cloud service provider and requests for the Virtual Infrastructure Management Module to start moving data to the provider site and also dynamically moves whole virtual servers to the cloud service provider's site as well after the data copy has finished. After the migration, the Service Director Module 200 directs any access request from the Client Host 150 to the cloud service provider's site.

The Server Resource Utilization History Table 202 holds the history of how much virtual server instance was used in the On Premise System 130. The Storage Resource Utilization History Table 203 holds the history of how much storage capacity was used in the On Premise System 130. The Server Resource Utilization Trend Table 204 holds the utilization trend information of virtual server instance in the On Premise System 130. The Storage Resource Utilization Trend Table 205 holds the utilization trend information of total storage capacity in the On Premise System 130. The Cloud Service Information Table 206 holds the basic information of migration target cloud services. The Cloud Service Data Transfer Performance History Table 207 holds the history of a certain amount of data copy throughput from the On Premise System 130 to the Cloud Service System 180. This table will be prepared for each of the migration candidate cloud services. The Cloud Service Data Transfer Performance Summary Table 208 holds the summary of a certain amount of data copy throughput from the On Premise System 130 to the Cloud Service System 180 and how much time will be needed for the entire data copy for actual migration.

3. Dynamic Resource Provisioning and Migration

FIG. 3 illustrates an example of a logical configuration showing the behavior for dynamic server/storage resource provisioning and its migration.

1) Resource Pool and Dynamic Provisioning

Whole servers 110 are logically integrated and compose a single Virtualized Server Pool 320 at the On Premise System 130. The pool represents a relatively large computing capacity that can provide the required amount of computing resource when requested. Similarly, storage systems 100 are logically integrated and compose a single Virtualized Storage Pool 310. The pool represents a relatively large amount of storage capacity that can provide the required amount of storage capacity (i.e., storage volume) when requested. The virtual infrastructure 300 is the entity that includes virtual servers 211 provisioned from the Virtualized Server Pool 320 and storage volumes 221 provisioned from the Virtualized Storage Pool 310, and it represents a logically constructed IT infrastructure to perform a certain application. Plural virtual infrastructures compose a cluster of platforms to perform an application workload. Thus, if the workload becomes high with utilizing most of the CPU or memory resource of those virtual infrastructures 300 within the cluster, new virtual infrastructures 300 can be added to the cluster to relieve the workload, or it could be said to perform a higher throughput by that cluster. Alternatively, virtual machines and/or capacity can be added to one or more of the existing virtual infrastructures 300 in the cluster.

2) Dynamic Migration with Data Copy

The virtual infrastructure 300 will be migrated from the On Premise System 130 to the Cloud Service System 180 when the workload experiences spiky high levels. First, as shown in FIG. 3, data in the storage volumes 221 are copied to the Cloud Service System 180 according to the Data Copy 360, and then whole virtual servers 211 are moved to the Cloud Service System 180 according to the Dynamic Migration 350.

4. Data Structure

1) Server Resource Utilization History Table

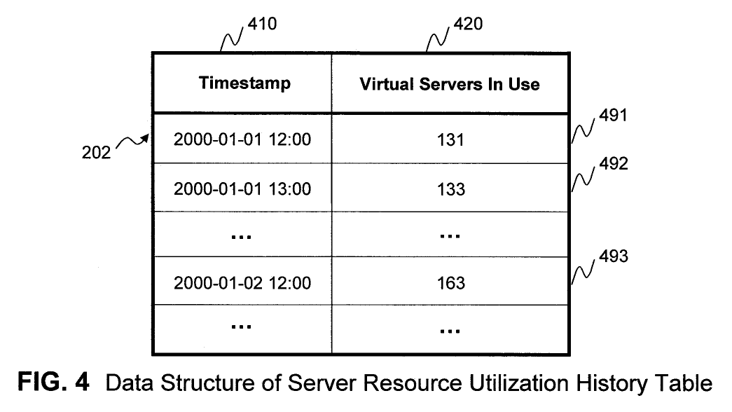

FIG. 4 shows an example data structure of the Server Resource Utilization History Table 202. It holds the history of how much virtual server instance was used in the On Premise System 130. It includes a timestamp 410 (time sampled) and virtual servers in use 420 (count of using virtual server instance at that time). The Virtual Infrastructure Management Module 201 periodically creates a new record and stores the latest virtual server count in use.

2) Storage Resource Utilization History Table

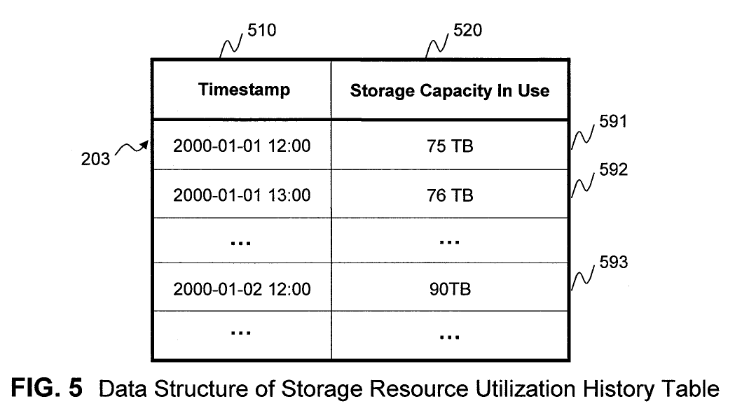

FIG. 5 illustrates an exemplary data structure of the Storage Resource Utilization History Table 203. It holds the history of how much storage capacity was used in the On Premise System 130. It includes a timestamp 510 (time sampled) and storage capacity in use 520 (capacity in use at that time). The Virtual Infrastructure Management Module 201 periodically creates a new record and stores the latest total storage capacity in use.

3) Server Resource Utilization Trend Table

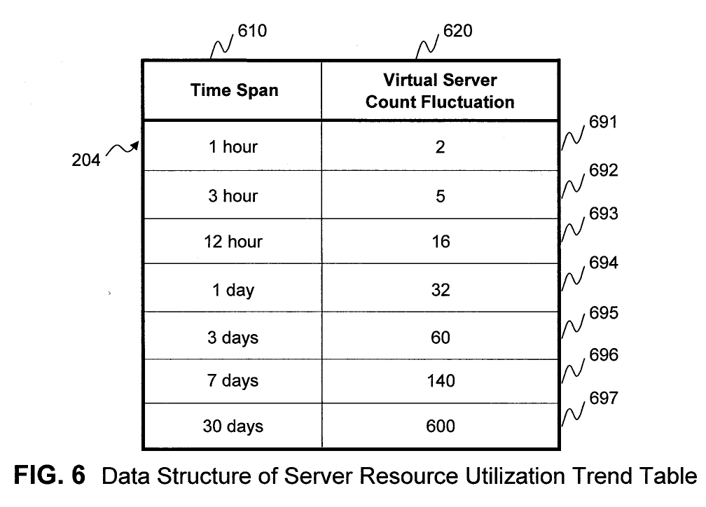

FIG. 6 illustrates an exemplary data structure of the Server Resource Utilization Trend Table 204. It holds the utilization trend information of virtual server instance in the On Premise System 130. It includes a time span 610 (time span of utilization trend information) and a virtual server count fluctuation 620 (fluctuation value of virtual server utilization within the time span). The Virtual Infrastructure Management Module 201 periodically calculates each time span of utilization trend based on the Server Resource Utilization History Table 202. Each fluctuation value can be calculated as equal to the latest virtual server count minus the value at a certain time before.

4) Storage Resource Utilization Trend Table

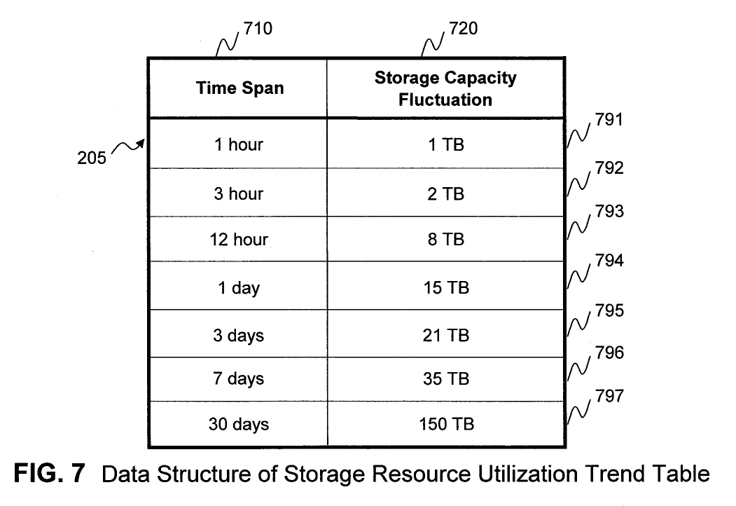

FIG. 7 illustrates an exemplary data structure of the Storage Resource Utilization Trend Table 205. It holds the utilization trend information of the total storage capacity in the On Premise System 130. It includes a time span 710 (time span of utilization trend information) and a storage capacity fluctuation 720 (fluctuation value of total storage capacity utilization within the time span). The Virtual Infrastructure Management Module 201 periodically calculates each time span of utilization trend based on the Storage Resource Utilization History Table 203. Each fluctuation value can be calculated as equal to the latest total storage capacity amount minus the value at a certain time before.

5) Cloud Service Information Table

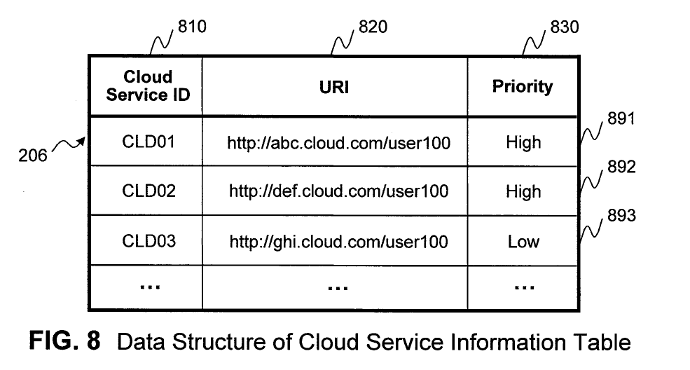

FIG. 8 illustrates an exemplary data structure of the Cloud Service Information Table 206. It holds the basic information of migration target cloud services. It includes the Cloud Service ID 810 (identification of the cloud service), URI 820 (Uniform Resource Identifier of the cloud service access point), and Priority 830 (priority to determine the cloud service as the final target of workload migration). The Priority 830 can be configured, for example, based on the price per virtual server instance by the number of virtual servers expected to be migrated.

6) Cloud Service Data Transfer Performance History Table

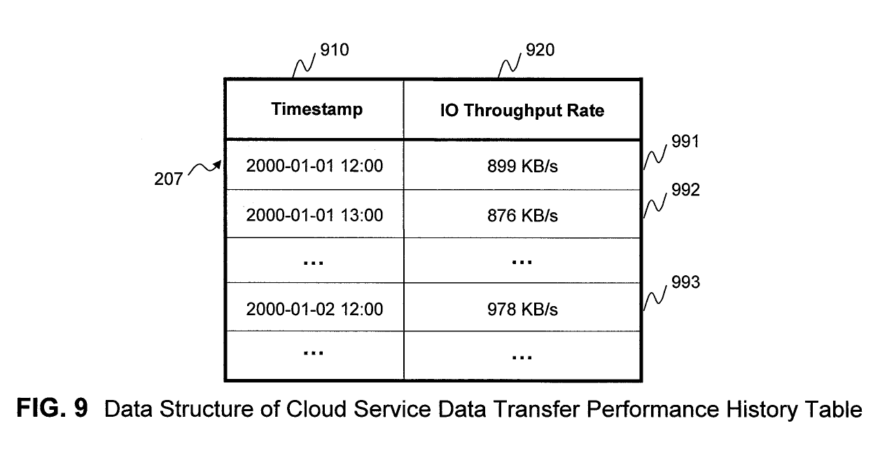

FIG. 9 illustrates an exemplary data structure of the Cloud Service Data Transfer Performance History Table 207. It holds the history of a certain amount of data copy throughput from the On Premise System 130 to the Cloud Service System 180. This table will be prepared for each of the migration candidate cloud services. It includes a timestamp 910 (time sampled) and an I/O throughput rate 920 (data copy rate tested at that time). The Service Director Module 200 periodically tests data sending, generally by http put method, to a specific cloud service and creates a new record of this table. It tests all the candidate cloud services and stores them to tables prepared for respective cloud services.

7) Cloud Service Data Transfer Performance Summary Table

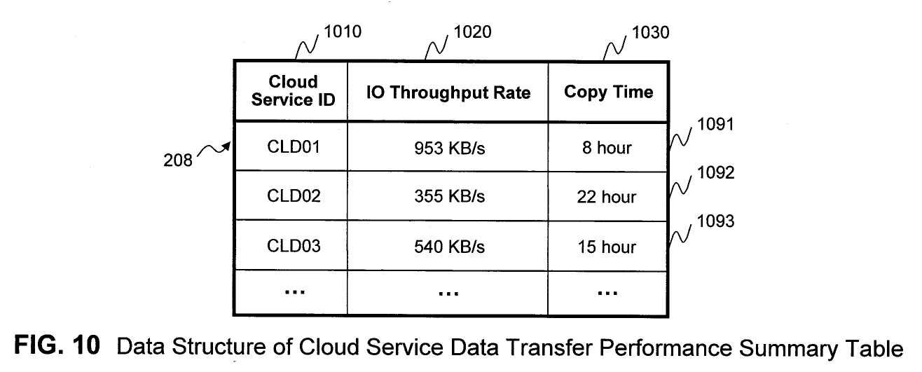

FIG. 10 illustrates an exemplary data structure of the Cloud Service Data Transfer Performance Summary Table 208. It holds the summary of certain amount of data copy throughput from the On Premise System to the Cloud Service System and how much time will be needed for the entire data copy for actual migration. It includes a Cloud Service ID 1010 (identification of the cloud service), an I/O throughput rate 1020 (recent data copy rate), and a copy time 1030 (estimated data copy amount of time for actual migration).

The Service Director Module 200 periodically calculates recent average data copy rate, such as one day average, for instance, based on the Cloud Service Data Transfer Performance History Table 207, for each of the cloud services. Based on the Storage Resource Utilization Trend Table 205, it estimates the total amount of data needed to copy in accordance with actual migration and determines the estimated copy time to complete that copy process from the On Premise System 130 to the respective Cloud Service Systems 180.

5. Process Flow

1) Process of Update Cloud Service Performance Information

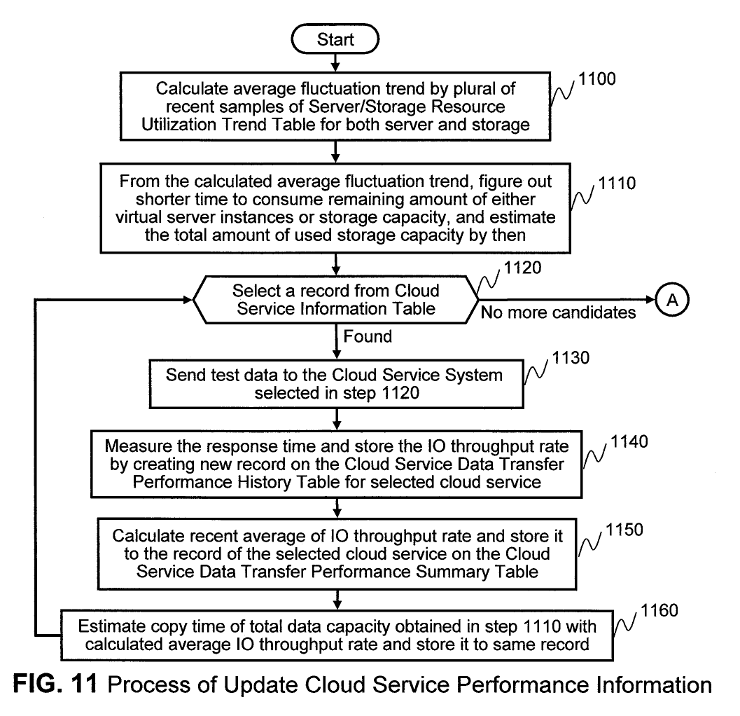

FIG. 11 is a flow diagram illustrating an example process of updating the performance information of each cloud service. This process is carried out by the Service Director Module 200 periodically, such as hourly, to refresh the I/O throughput rate of each cloud service. For this process, at least a small amount of storage capacity for test data will be stored at each cloud service temporarily but it can be removed after the test.

In step 1100, it calculates the average fluctuation trend by plural recent samples of the Server Resource Utilization Trend Table 204 and Storage Resource Utilization Trend Table 205 for both server and storage. Based on the resource utilization trend information, it estimates the total amount of data that needs to be copied for the actual workload migration. It is assumed that the Virtual Infrastructure Management Module 201 periodically collects virtual server instance and storage capacity utilization (Server Resource Utilization History Table 202 and Storage Resource Utilization History Table 203) and updates trend information (Server Resource Utilization Trend Table 204 and Storage Resource Utilization Trend Table 205). From some recent time span (e.g., 1 hour to 12 hours) of trend information, step 1100 calculates its average. In step 1110, based on the calculated average fluctuation trend, it figures out a shorter time to consume the remaining amount of either virtual server instances or storage capacity, and estimates the total amount of used storage capacity by then. The remaining amount of resource may be the entire amount of the On Premise System 130 or a predefined threshold amount.

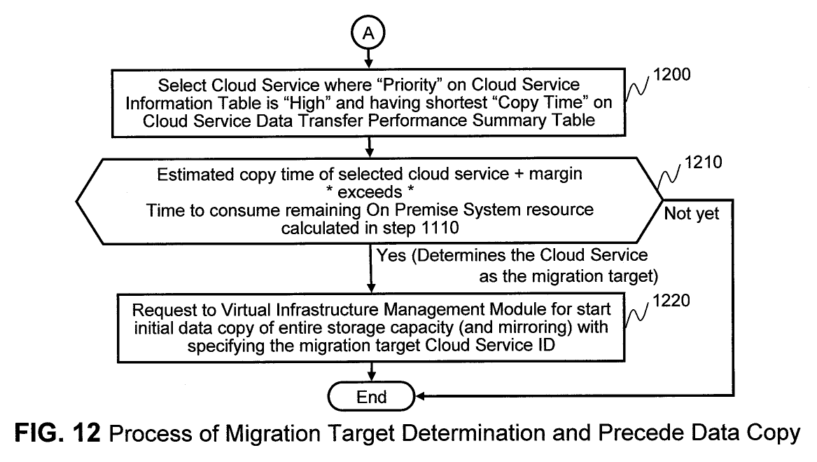

In step 1120, it selects a record from the Cloud Service Information Table 206. If there are no more candidates, the process proceeds to FIG. 12. If a candidate is found, the process proceeds to step 1130. In step 1130, it sends the test data to the Cloud Service System 180 selected in step 1120. In step 1140, it measures the response time and stores the calculated I/O throughput rate to its history table by creating a new record on the Cloud Service Data Transfer Performance History Table 207 for the selected cloud service. In step 1150, it calculates the recent average of the I/O throughput rate (e.g., last 1 day) and stores it to the record of the selected cloud service on the Cloud Service Data Transfer Performance Summary Table 208. In step 1160, it estimates the copy time of the total data capacity obtained in step 1110 with the calculated average I/O throughput rate as well as the estimated total storage capacity of migration data, and stores the copy completion time to the same record.

2) Process of Migration Target Determination and Precede Data Copy

FIG. 12 is a flow diagram illustrating an example process of migration target cloud service determination and precede data copy. This process is carried out by the Service Director Module 200 if there are no more candidates in step 1120 in the Update Cloud Service Performance Information process of FIG. 11 above. The term “precede” data copy means data copy that starts in advance of the time of workload migration, so as to shorten or eliminate the application disruptive time.

In step 1200, it selects the cloud service in which the “priority” on the Cloud Service Information Table 206 is “high” and which has the shortest “copy time” on the Cloud Service Data Transfer Performance Summary Table 208. That is, it selects the cloud service which is “High” priority and has measured the fastest I/O throughput rate.

In step 1210, it estimates the copy time of the selected cloud service plus some predefined amount of margin time such that the sum exceeds the calculated time to consume the remaining resource of the On Premise System 130 in step 1110, and then determines the selected cloud service as the migration target and starts precede data copy to the migration target. The sum of the estimated copy time and the margin time is the difference between a start time (for starting the precede data copy) and a switching time (for switching over processing of the workload to be migrated from the on premise system to the cloud service system).

In step 1220, it sends a request to the Virtual Infrastructure Management Module 201 for starting the initial data copy of the entire storage capacity (and mirroring) with specifying the migration target Cloud Service ID. The actual data copy of each virtual infrastructure will be done by the Virtual Infrastructure Management Module 201, and thus the Service Director Module 200 requests for starting the initial data copy of the storage volume of the entire virtual infrastructures with specifying the migration target Cloud Service ID. As a result, the Virtual Infrastructure Management Module 201 can get access information of the cloud service from the Cloud Service Information Table 206.

3) Process of Workload Migration

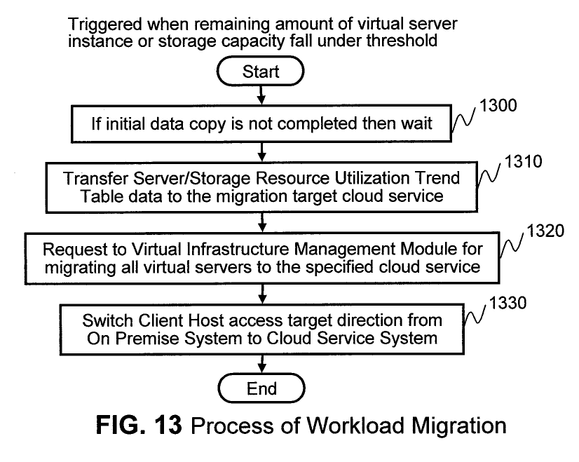

FIG. 13 is a flow diagram illustrating an example process of entire workload migration from the On Premise System 130 to the selected Cloud Service System 180. This process is carried out by the Service Director Module 200 when the remaining amount of virtual server instances or storage capacity falls under a predefined threshold.

In step 1300, if the initial data copy is not completed, then it waits. In step 1310, it transfers data from the Server Resource Utilization Trend Table 204 and the Storage Resource Utilization Trend Table 205 to the migration target loud service. In this embodiment, the Cloud Service System 180 supports the mechanism (described below) of the automated proper amount of resource provisioning according to the growth trend of resource consumption. Therefore, during the workload migration, the collected resource utilization trend information is transferred to the Cloud Service System 180 so that the Cloud Service System 180 can immediately begin the automated provisioning after the migration process based on the trend information collected in the On Premise System 130, and can update the trend data by the usage at the Cloud Service System 180 after that.

In step 1320, it sends a request to the Virtual Infrastructure Management Module 201 for migrating all virtual servers to the specified cloud service for the virtual infrastructures with specifying the migration target Cloud Service ID. In step 1330, it switches the Client Host access target direction from the On Premise System 130 to the Cloud Service System 180.

4) Process of Virtual Server Provisioning

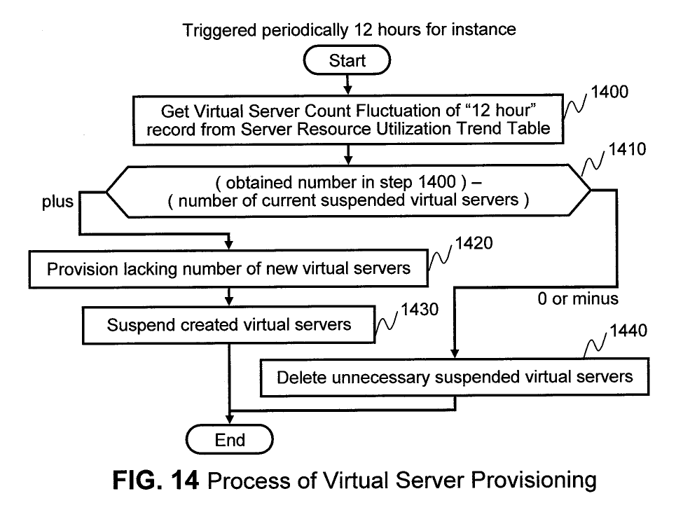

FIG. 14 is a flow diagram illustrating an example process of automated virtual server provisioning based on the resource utilization trend information. This process is carried out by the Virtual Infrastructure Management Module 201 periodically such as once every 12 hours in this example. This process is performed against the On Premise System 130 before the workload migration and, after the migration it will be done in the Cloud Service System initially based on the transferred resource utilization trend information in step 1310.

In step 1400, it gets the Virtual Server Count Fluctuation of “12 hour” record from the Server Resource Utilization Trend Table 204, and checks for whether enough suspended virtual servers are queued or not. This is done by calculating (obtained number in step 1400)−(number of current suspended virtual servers) in step 1410. In this example, the 12 hour fluctuation value is the expected amount of required virtual servers to be added to the server cluster. If the calculation in step 1410 produces a positive value, the process proceeds to steps 1420-1430. If it produces zero or a negative value, the process proceeds to step 1440.

In step 1420, where the obtained number in step 1400 is not enough, it provisions the lacking number of new virtual servers to achieve the required number of virtual servers. In step 1420, it suspends the new virtual servers, and places them in the queue. In step 1440, where the obtained number in step 1400 is enough (i.e., the suspended number is enough or exceeds the required number), it deletes any unnecessary virtual server instances from the queue.

5) Process of Virtual Server Execution

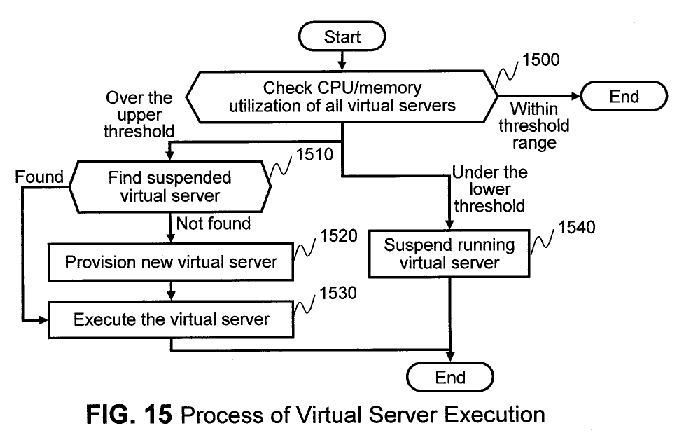

FIG. 15 is a flow diagram illustrating an example process of adjusting the required number of virtual servers for execution. This process is carried out by the Virtual Infrastructure Management Module 201 periodically such as once very 5 minutes. This process is performed against the On Premise System 130 before the workload migration and, after the migration it will be done in the Cloud Service System 180.

In step 1500, it checks for all virtual servers' CPU/memory utilization to determine whether the utilization is too low or too high based on the higher and lower side of the predefined threshold. If the utilization is within the threshold range, the process ends. If the utilization is over the upper threshold, the process proceeds to steps 1510-1530. If the utilization is under the lower threshold, the process proceeds to step 1540.

If the workload is too high and there is a need to add more virtual server instance to the cluster, it looks for the suspended virtual server in step 1510 and resumes the instance. If there is no suspended instance, it provisions new virtual server in step 1520. Finally, it executes the virtual server in step 1530. On the other hand, if the workload is too low, it suspends running virtual server in step 1540.

The following is a summary of the IT source migration method described above. In the On Premise Site 130, (physical) servers 110 can provision plural virtual servers 211 and logically form the Virtualized Server Pool 320, and storage systems 100 can provision plural storage volumes 221 and form the Virtualized Storage Pool 310. At the off premise (cloud service provider) site, logical Virtualized Server Pool 320 and Virtualized Storage Pool 310 are provided to be used as a service, which is accessed via the Internet.

The Service Director Module 200 is provided on the Service Director Server 140 at the on premise site is placed between the Client Host 150 that utilizes the IT resources and the on/off premise IT sources connected by the network. The Service Director Module 200 directs the access request from Client Host 150 to either the on premise site system or the off premise cloud service site system properly where workloads are running currently. The Virtual Infrastructure Management Module 201 also on the Service Director Server 140 manages the lifecycle of the virtual servers 211 and storage volumes 221. It monitors the history of how much computing and storage resources have been utilized at the site, and generates the utilization trend information. Based on the trend information, it provisions the proper amount of virtual servers 211 periodically in advance to the actual need of adding them to the cluster of server workloads and queues them for use at a later time. When those virtual server instances are needed according to the growth of transactions, they will be added to the cluster and turned on from the suspended state.

The Service Director Module 200 periodically checks the I/O performance (data “put” throughput) for migration candidate cloud services by sending a small amount of actual data. It also estimates how much time will be needed to transfer the whole amount of data during the actual migration from on premise site to each candidate cloud service sites based on the measured throughput. The Service Director Module 200 then figures out how much time is left to utilize a certain determined amount of resource at the on premise site based on the trend information, which is the time the workloads need to be migrated from the on premise site to the off premise site, and compares it to the estimated time of data copying to the cloud service site as discussed above. If they are sufficiently close, it determines the migration target cloud service provider and requests for the Virtual Infrastructure Management Module 201 to start moving data to the cloud service provider site. Then when actually the on premise site resource utilization reaches the limit or threshold, it also requests for the dynamic migration of all virtual servers 211 to the cloud service provider's site. After the migration, the Service Director Module 200 directs any access request from the Client Host 150 to the cloud service provider's site.

By measuring both the real time throughput to the migration target cloud service site and the resource utilization trend of the on premise site, the source migration method can figure out the proper time to start data copy in advance to the actual switch over process of server workloads (i.e., precede data copy), and hence it can shorten or eliminate the application disruptive time due to the data copy time for the site migration from the on premise site to the off premise cloud service provider's site.

The IT source migration technique is used on the IT system in which application workloads on the company-owned on premise site can be dynamically migrated to the external cloud service providers' site, especially if the application has the characteristic that encounters spiky increases of transactions in a short period of time. The migration technique also can be applied to the source migration between two external cloud services or between two system environments within an on premise site. Between two external cloud services, timing of the migration may be based on the price per virtual server usage, for instance. Because the price system varies in cloud services, cloud (A) may be more reasonable to use until the virtual server instance usage reaches count X (i.e., lower cost than cloud (B)); however, beyond that count X, using cloud (B) is more reasonable (i.e., lower cost than cloud (A)). Therefore, “count X” will be the point to trigger the migration between those cloud services in this case.

Of course, the system configurations illustrated in FIGS. 1-3 are purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for an IT source migration method to shorten or eliminate the application disruptive time due to the data copy time from the on premise site to the off premise cloud service provider's site. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A method of managing IT (Information Technology) sources among a first computer system and at least one computer service system which are connected with a network, the method comprising:
obtaining a resource utilization trend of the first computer system based on a history of utilization of an IT resource in the first computer system;
obtaining a data sending throughput rate from the first computer system to each of the at least one computer service system;
selecting, based on the resource utilization trend and the data sending throughput rate, a target computer service system among the at least one computer service system to migrate a workload from the first computer system to the target computer service system;
determining, based on the resource utilization trend and the data sending throughput rate, a start time to start a precede data copy associated with the workload to be migrated from the first computer system to the target computer service system, prior to switching over processing of the workload to be migrated from the on premise system to the target computer service system at a switching time; and
starting the precede data copy associated with the workload to be migrated from the first computer system to the target computer service system at the start time.

2. A method according to claim 1,
wherein obtaining the data sending throughput rate comprises sending a small amount of data from the first computer system to each of the at least one computer service system periodically to obtain a real-time data sending throughput rate for each of the at least one computer service system.

3. A method according to claim 1,
wherein the determining includes determining the start time such that a difference between the start time and the switching time is at least equal to an estimated copy time of a total amount of data associated with the workload to be migrated from the first computer system to the target computer service system.

4. A method according to claim 3,
wherein the starting of the precede data copy is triggered when remaining time to consume rest of the IT resource in the first computer system calculated based on the resource utilization trend becomes lower than the estimated copy time plus a margin.

5. A method according to claim 1, further comprising:
migrating the workload from the first computer system to the target computer service system either immediately after completion of the precede data copy or by an independent trigger.

6. A method according to claim 5, wherein if the independent trigger is activated and the precede data copy has not been completed, migration of the workload waits until the precede data copy is completed.

7. A method according to claim 5, further comprising:
transferring the resource utilization trend of the first computer system to the target computer service system during migration of the workload to the target computer service system.

8. A method according to claim 7, wherein the IT resource includes at least one of virtual server instances and storage capacity, the method further comprising:
starting automated virtual server provisioning in the target computer service system based on the resource utilization trend transferred from the first computer system.

9. A method according to claim 1,
wherein the at least one computer service system includes at least one cloud service system; and
wherein the first computer system is one of an on premise computer system or another cloud service system.

10. A method according to claim 1, further comprising:
monitoring both a server resource consumption trend and a storage resource consumption trend of the first computer system;
determining which of the server resource and the storage resource will be first to be consumed down to a corresponding threshold level, the threshold level being equal to or greater than zero;
calculating a consumed storage amount of the storage resource when the threshold level is first reached; and
using the calculated consumed storage amount for determining the start time.

11. A method according to claim 1, further comprising:
selecting the target computer service system which has a shortest copy time for the precede data copy.

12. A method according to claim 11, wherein the target computer service system having the shortest copy time is selected by referring to a data transfer performance summary table containing, for each computer service system, an ID, an I/O throughput rate, and an estimated copy time.

13. A method according to claim 1, further comprising:
after completion of migrating the workload from the first computer system to the target computer service system, directing an access target for the first computer system to the target computer service system instead of to the first computer system.

14. A management system for managing IT (Information Technology) sources, the management system comprising:
a first computer system;
at least one computer service system; and
a service director computer connected to the first computer system and the at least one computer service system via a network, wherein the service director computer
obtains a resource utilization trend of the first computer system based on a history of utilization of an IT resource in the first computer system;
obtains a data sending throughput rate from the first computer system to each of the at least one computer service system;
selects, based on the resource utilization trend and the data sending throughput rate, a target computer service system among the at least one computer service system to migrate a workload from the first computer system to the target computer service system;
determines, based on the resource utilization trend and the data sending throughput rate, a start time to start a precede data copy associated with the workload to be migrated from the first computer system to the target computer service system, prior to switching over processing of the workload to be migrated from the on premise system to the target computer service system at a switching time; and
starts the precede data copy associated with the workload to be migrated from the first computer system to the target computer service system at the start time.

15. A management system according to claim 14,
wherein the start time is determined such that a difference between the start time and the switching time is at least equal to an estimated copy time of a total amount of data associated with the workload to be migrated from the first computer system to the target computer service system.

16. A management system according to claim 15,
wherein the starting of the precede data copy is triggered when remaining time to consume rest of the IT resource in the first computer system calculated based on the resource utilization trend becomes lower than the estimated copy time plus a margin.

17. A management system according to claim 14, wherein the service director computer further:
migrates the workload from the first computer system to the target computer service system after completion of the precede data copy either immediately after completion of the precede data copy or by an independent trigger.

18. A management system according to claim 17, wherein the service director computer further:
transfers the resource utilization trend of the first computer system to the target computer service system during migration of the workload to the target computer service system.

19. A management system according to claim 18,
wherein the IT resource includes at least one of virtual server instances and storage capacity, and
wherein the service director computer starts automated virtual server provisioning in the target computer service system based on the resource utilization trend transferred from the first computer system.

20. A computer-readable storage medium storing a plurality of instructions for controlling a data processor to manage IT (Information Technology) sources among a first computer system and at least one computer service system which are connected with a network, the plurality of instructions comprising:
instructions that cause the data processor to obtain a resource utilization trend of the first computer system based on a history of utilization of an IT resource in the first computer system;
instructions that cause the data processor to obtain a data sending throughput rate from the first computer system to each of the at least one computer service system;
instructions that cause the data processor to select, based on the resource utilization trend and the data sending throughput rate, a target computer service system among the at least one computer service system to migrate a workload from the first computer system to the target computer service system;
instructions that cause the data processor to determine, based on the resource utilization trend and the data sending throughput rate, a start time to start a precede data copy associated with the workload to be migrated from the first computer system to the target computer service system, prior to switching over processing of the workload to be migrated from the on premise system to the target computer service system at a switching time; and
instructions that cause the data processor to start the precede data copy associated with the workload to be migrated from the first computer system to the target computer service system at the start time.
